(19) United States
(12) Patent Application Publication
(10) Pub. No.: US 2026/0072684 A1
(43) Pub. Date: Mar. 12, 2026

(54) MASKING/ZEROING PREDICATION IN PROCESSOR CIRCUITS

(71) Applicant: Apple Inc., Cupertino, CA (US)

(72) Inventors: Jeff GONION, Campbell, CA (US); Charles E. TUCKER, San Jose, CA (US)

(21) Appl. No.: 19/094,393

(22) Filed: Mar. 28, 2025

Related U.S. Application Data
(60) Provisional application No. 63/692,851, filed on Sep. 10, 2024.

(51) Int. Cl. G06F 9/30; G06F 9/38

(52) U.S. Cl. CPC G06F 9/30038; G06F 9/3887

(57) ABSTRACT

A processor circuit that can perform predicated vector operations is disclosed. The processor circuit may compare source and destination register locations as identified in a fetched vector instruction that specifies a predicate vector. The processor circuit may also execute the fetched vector instruction based on the predicate vector to generate an output vector. Based on a result of the comparison of the respective names of source and destination registers, the processor circuit may determine values for inactive elements in the output vector by either zeroing the inactive elements in the output vector prior to writing to the destination register or by masking a write of the inactive elements of the output vector to the destination register.

### CROSS-REFERENCE TO RELATED APPLICATIONS

The present application claims the benefit of U.S. Provisional Application No. 63/692,851, entitled “MASKING/ZEROING PREDICATION IN PROCESSOR CIRCUITS,” filed Sep. 10, 2024, the content of which is incorporated by reference herein in its entirety for all purposes.

### FIELD

The described embodiments relate generally to processor circuits and, more particularly, to predicated vector instructions.

### BACKGROUND

Computer systems can include one or more processor circuits that execute software or program instructions to perform certain tasks. The software or program instructions can be stored in a memory circuit until needed. Prior to executing a given software or program instruction, the processor circuit may retrieve or fetch the given software or program instruction from the memory circuit.

Processor circuits can be classified based on how data items are processed. For example, scalar processor circuits can operate on one data element at time, while vector processor circuits can operation on multiple data elements in parallel. Scalar processor circuits can be used for general-purposed computing tasks, e.g., word processing, spreadsheets, and the like, and are typically slower and more energy efficient than their vector counterparts. Vector processor circuits can be used for compute-intensive applications such as graphics or image processing, virtual and augmented reality, artificial intelligence, and the like, at the expense of increased cost and power consumption.

### BRIEF DESCRIPTION OF THE DRAWINGS

FIG. 1 is a block diagram depicting an embodiment of a processor circuit.

FIG. 2 is a block diagram depicting an embodiment of a vector instruction.

FIG. 3 is a block diagram depicting an embodiment of a format circuit.

FIG. 4 is a block diagram depicting an embodiment of a register circuit.

FIG. 5 is a flow diagram depicting an embodiment of a method for operating a processor circuit.

FIG. 6 is a block diagram of an embodiment of a device that includes a processor circuit.

FIG. 7 is a block diagram of various embodiments of computer systems that may include processor circuits.

FIG. 8 illustrates an example of a non-transitory computer-readable storage medium that stores circuit design information.

### DETAILED DESCRIPTION

Computer systems may include one or more processor circuits to execute software or program instructions. Such program instructions may include instructions to fetch data or operands from memory, perform arithmetic computations, store computed values into memory, and the like. In some cases, the program instructions can include both scalar instructions that operate on one or more scalar values, and vector instructions that operation on one or more vectors.

In some instruction set architectures (“ISAs”), a predicate input may be accepted for vector operations. Such predicate inputs can include multiple predicate elements that identify on which portions of vector operands are to be processed. This allows for operating on certain vector lanes conditionally, either statically or dynamically. In the static case, particular vector lanes, e.g., the first, the third, the fourth, are active while the other lane are disable. In the dynamic case, predicate information may be combined using Boolean operations to determine which vector lanes are active.

There are different techniques to deal with inactive lanes during predicated vector operations. In some cases, a process referred to as “zeroing” is employed in which inactive lanes of a processor circuit output a zero into an output vector. Alternatively, a process referred to as “masking,” “blending,” or “undisturbed” may be employed where a processor circuit maintains the previous values of a destination vector in the inactive locations.

Predication with masking requires that a processor circuit maintain previous values so that they are available when an output vector of a vector instruction is generated. In processor circuits which do not support register renaming and have a short pipeline, having previous values available is generally not an issue, with an output value being written back to a physical registers file in the same storage location as the previous values. In such cases, a per-lane enable bit can be employed to prevent inactive lane information from being written to the physical register file.

In microarchitectures that support register renaming, the output write back may be to a different physical register file and, therefore, must read the previous value in order to perform the masking operation. The extra read adds an implicit source to a masking operation. In cases, where all of the vector lanes are active, the implicit source is a false dependency as none of the previous value is needed. Waiting for the read of the previous value is wasted time, power, and resources, as none of the information is actually used in determining the output vector. Processor circuits that allow for renaming can be more efficient with operations that define an entire register output to avoid this false dependency and thus are better with zeroing behavior. For smaller processor cores that do not allow renaming, performing zeroing predication can require redundant writes of logical-O values to the destination register. Neither zeroing nor masking are ideal for all types of processor circuits. In the case of a masking operation which is destructive, i.e., the output write is to the same register as one of its inputs, the previous register contents become a dependence.

The embodiments illustrated in the drawings and described below provide techniques for performing either zeroing or masking based on a coincidence of an operation's destination with any of its sources. In the case when the operation's output register matches any of its source registers, masking can be performed, otherwise zeroing is performed. By detecting the condition where the output register matches one of the source registers, masking can be performed without the use of explicit encoding bits, while still allowing assemblers and compilers to specify masking or zeroing based on the choice of registers. Moreover, renaming processor circuits do not need to infer an extra source register or have false dependencies interfere with out-of-order execution.

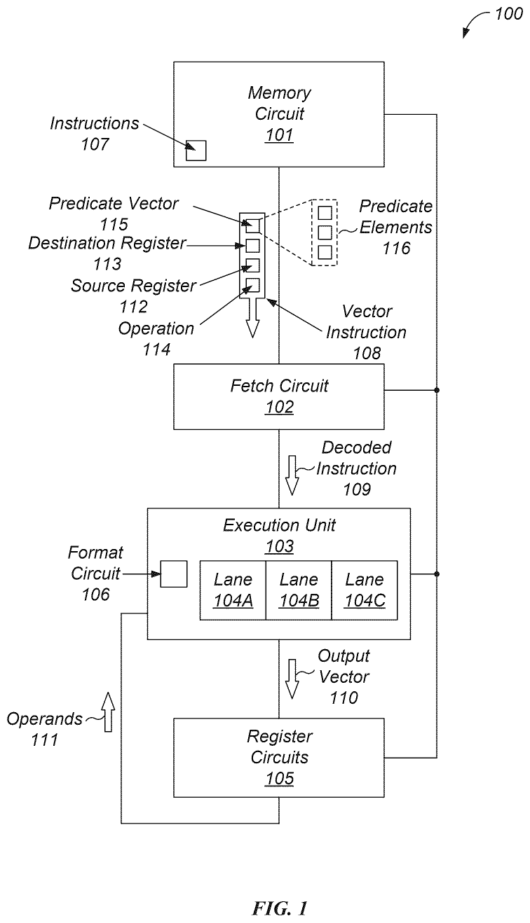

A block diagram of a processor circuit is depicted in FIG. 1. As illustrated, processor circuit 100 includes memory circuit 101, fetch circuit 102, execution circuit 103, and register circuits 105.

Memory circuit 101 is configured to store instructions 107. In various embodiments, instructions 107 may include one or more vector instructions including vector instruction 108. Memory circuit 101 may, in some embodiments, be configured to store data that can be used as operands for instructions 107, as well as store output data resulting from the execution of instructions 107. In various embodiments, memory circuit 101 may be implemented using static random-access memory (“SRAM”) circuits, dynamic random-access memory (“DRAM”) circuits, or any other suitable type of memory circuits.

Fetch circuit 102 is configured to retrieve vector instruction 108 from a memory circuit 101. In various embodiments, vector instruction 108 specifies operation 114, source register 112 which store operands 111, destination registers 113, and predicate vector 115 that includes a predicate elements 116. In some embodiments, fetch circuit 102 may include a decoder circuit configured to decode vector instruction 108 once it has been fetched from memory circuit 101 to generate decoded instruction 109.

In various embodiments, the registers specified in vector instruction 108, i.e., source register 112 and destination register 113, are physically located in register circuits 105. In various embodiments, destination register 113 is configured to hold output vector 110 associated with the operation 114, and source registers 112 is configured to hold operands 111. As used herein, when a register is said to hold data, it refers to maintaining data received via a store operation for subsequent use until the data is clear, overwritten, or the like.

Format circuit 106 is configured to perform a comparison of respective names of source register 112 and destination register 113. As described below, to perform the comparison, format circuit 106 may be configured to compare respective numbers corresponding to the names of source register 112 and destination registers 113. Although format circuit 106 is depicted as being included in execution circuit 103, in other embodiments, format circuit 106 may be grouped with different functional circuit blocks included in processor circuit 100.

Execution circuit 103 is configured to perform, using operands 111 and predicate vector 115, the operation to generate output vector 110. In various embodiments, some elements of output vector may be inactive, i.e., the operation was not performed using the corresponding elements of operands 111. It is noted that in some cases, all of the elements may inactive o\r all of the elements may be active. Which, if any, elements of output vector 110 are inactive may, in different embodiments, may be based on corresponding values of predicate elements 116 of predicate vector 115. For example, inactive elements of output vector 110 may be identified by different ones of predicate elements 116 that have a logical-0 value.

In various embodiments, execution circuit 103 includes lanes 104A-104C that are configured to operate on respective portions of operands 111 as indicated by the active element positions of predicate elements 116. In some embodiments, different ones of lanes 104A-104C that are not active may be placed in a low-power state. Although only four lanes are depicted in the embodiment of FIG. 1, in other embodiments, any suitable number of lanes may be included in execution circuit 103. In some cases, the number of lanes included in execution circuit 103 may correspond to a width of a vector in operands 111.

In various embodiments, execution circuit 103 is also configured to determine, based on a result of the comparison, respective values for inactive elements in output vector 110. Execution circuit 103 may, in some embodiments, be further configured to write active elements of output vector 100 to destination register 113.

In some embodiments, to determine the respective values for the inactive elements of output vector 110, execution circuit 103 is further configured, in response to a determination that the name of destination register 113 does not match name of source register 112, to set the inactive elements of output vector 110 to logical-0 values. In other embodiments, execution circuit 103 is further configured to write the logical-0 values, along with the active elements of output vector 110, to destination register 113.

In various embodiments, to determine the respective values for the inactive elements of output vector 110, execution circuit 103 is further configured, in response to a determination that the name of destination register 113 matches the name of source register 112, retain the values from destination register 113 that correspond to the inactive elements of output vector 110. In some embodiments, to retain the values from destination register 113, execution circuit 103 is further configured to mask a write operation of the inactive elements of output vector 110 to destination register 113.

In some cases, destination register 113 includes a plurality of storage circuits, and to mask the write operation, execution circuit 103 is further configured to deactivate, based on the predicate vector, a plurality of write signals that control the write operation to corresponding ones of the plurality of storage circuits. In other embodiments, to retain the values from destination register 113, execution circuit 103 is further configured to save the values from destination register 113, and write the values saved from destination register 113, along with active elements of output vector 110, to destination register 113.

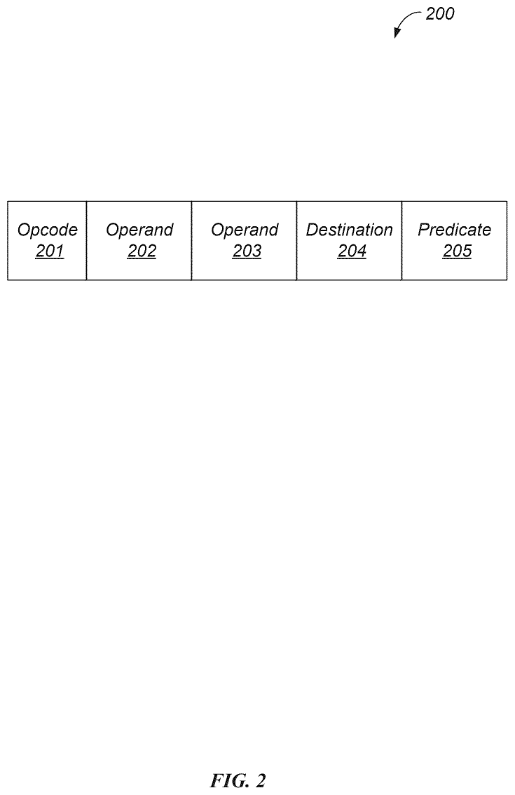

A block diagram of an embodiment of a vector instruction is depicted in FIG. 2. As illustrated, vector instruction 200 includes multiple fields including fields for opcode 201, operand 202, operand 203, destination 204, and predicate 205. Although only five fields are depicted in vector instruction 200, in other embodiments, any suitable number of fields may be employed.

In various embodiments, opcode 201 may specify operation 114. In some embodiments, opcode 201 may be encoded. In such cases, fetch circuit 102 may include a decode circuit configured to decode opcode 201 to determine operation 114.

Operand 202 and operand 203 specify addresses of source registers, e.g., source register 112, wherein operands 111 are stored in register circuits 105. Although two operands are depicted in the embodiment of FIG. 2, in other embodiments, only a single operand may be specified.

In a similar fashion, destination 204 specifies an address of destination register 113, and predicate 205 specifies an address for predicate vector 115 in register circuits 105. In various embodiments, the address of destination register 113 specifies a location in register circuits 105 where output vector 110 is to be stored.

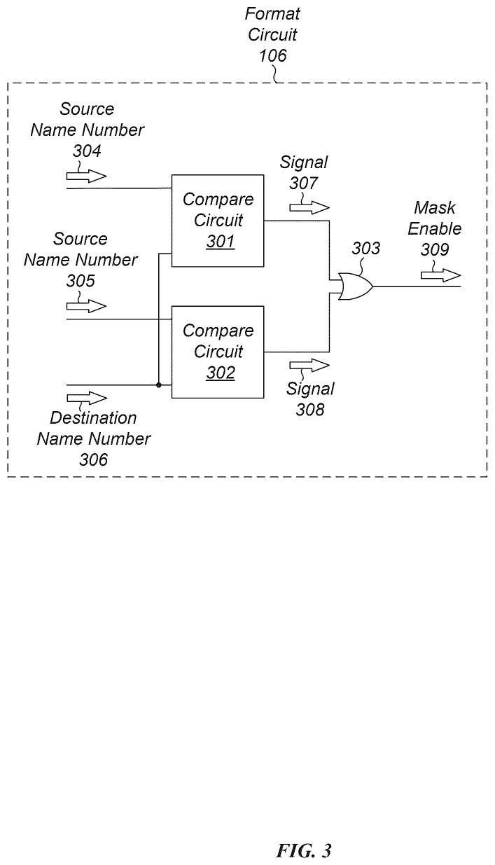

In various embodiments, the names of source and destination registers may be represented as numbers using any suitable format. In such cases, to compare source and destination register names, format circuit 106 may be configured to compare the numbers that correspond to the names. A block diagram of an embodiment of format circuit 106 is depicted in FIG. 3. As illustrated, format circuit 106 includes compare circuit 301, compare circuit 302, and OR-gate 303.

Compare circuit 301 is configured to generate signal 307 using source name number 304 and destination name number 306. In a similar fashion, compare circuit 302 is configured to generate signal 308 using source name number 305 and destination name number 306. In various embodiments, source name numbers 304 and 305 may correspond to registers where operands 202 and 203 are being held, and destination name number 306 may correspond to destination 204 where a result from performing the operation specified by opcode 201 is to be stored. Although format circuit 106 is depicted as being configured to compare two source numbers to a single destination number, in other embodiments, any suitable number of source numbers may be employed. It is noted that source name number 304, source name number 305, and destination name number 306 may be mapped to different ones of physical addresses associated with register circuits, e.g., register circuits 105 as depicted in FIG. 1.

To generate signal 307, compare circuit 301 is configured to perform a bitwise comparison of source name number 304 and destination name number 306, such that signal 307 is activated in response to a determination that source name number 304 matches destination name number 306. In various embodiments, compare circuit 301 may be implemented using multiple exclusive-OR logic gates, or any other suitable combination of logic gates configured to perform the bitwise comparison.

To generate signal 308, compare circuit 302 is configured to perform a bitwise comparison of source name number 305 and destination name number 306, such that signal 308 is activated in response to a determination that source name number 305 matches destination name number 306. In various embodiments, compare circuit 302 may be implemented using multiple exclusive-OR logic gates, or any other suitable combination of logic gates configured to perform the bitwise comparison.

OR-gate 303 is configured to generate mask enable 309 using signal 307 and signal 308. In various embodiments, to generate mask enable 309, OR-gate 303 is configured to perform a logical-OR operation using signal 307 and signal 308, and activate mask enable 309 in response to a determination that either of signal 307 or signal 308 is active. In various embodiments, OR-gate 303 may be implemented using multiple metal-oxide semiconductor field-effect transistors (“MOSFETs”), Fin field-effect transistors (“FinFETs”), gate-all-around field-effect transistors (“GAAFETs”), or any other suitable transconductance devices.

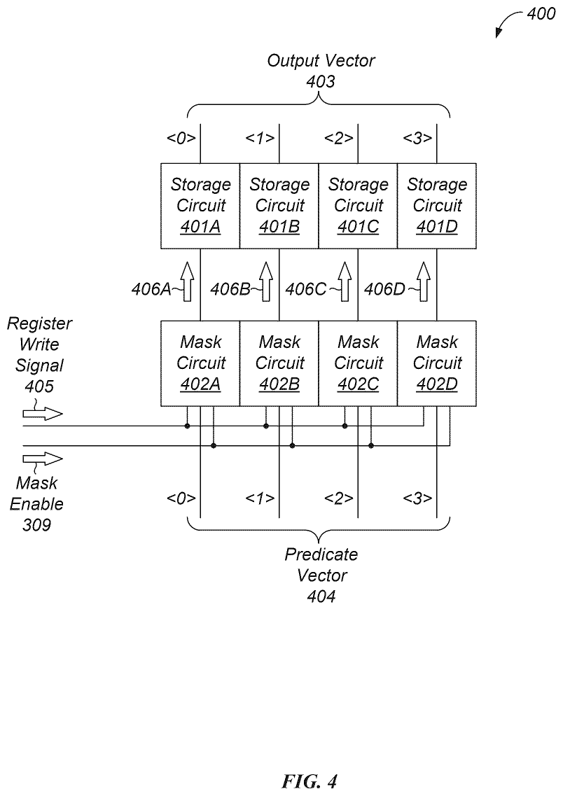

Turning to FIG. 4, a block diagram depicting an embodiment of a register circuit is depicted. As illustrated, register circuit 400 includes storage circuits 401A-401D and mask circuits 402A-402D. In various embodiments, register circuit 400 may corresponding to one or more of the register circuits included in register circuits 105. Although four storage circuits and four mask circuits are employed in the embodiment of FIG. 4, in other embodiments, any suitable number of storage circuits and mask circuits may be employed.

Storage circuits 401A-401D are configured to store corresponding bits of output vector 403 in response to the activation of corresponding ones of signals 406A-406D. For example, in response to an activation of signal 406A, storage circuit 401A stores bit<0> of output vector 403. In various embodiments, output vector 403 may correspond to output vector 110 as depicted in FIG. 1. Storage circuits 401A-401D may be implemented using latch circuits, flip-flop circuits, or any other suitable circuit configured to store a digital value.

Mask circuits 402A-402D are configured to generate signals 406A-406D using register write signal 405, mask enable 309, and corresponding bits of predicate vector 404. In various embodiments, predicate vector 404 may be stored at a location specified in the predicate 205 field of vector instruction 200 as depicted in FIG. 2.

To generate signals 406A-406D, mask circuits 402A-402D are further configured to perform a logical-AND operation using register write signal 405, mask enable 309, and corresponding ones of predicate vectors 404. For example, mask circuit 402A is configured to activate signal 406A in response to a determination that register write signal 405, mask enable 309, and bit<0> of predicate vector 404 all have logical-1 values.

In various embodiments, mask circuits 402A-402D may be implemented using a combination of NAND gates and inverter circuits. In other embodiments, mask circuits 402A-402D may be implemented using complex logic gates constructed from multiple MOSFETs, FinFETs, GAAFETs, or any other suitable transconductance devices.

To summarize, a processor circuit is disclosed. Broadly speaking, the processor circuit may include a fetch circuit, a plurality of register circuits, a format circuit, and an execution circuit. The fetch circuit can be configured to retrieve a vector instruction from a memory circuit. The vector instruction may specify an operation, one or more operands, and a predicate vector that includes a plurality of predicate elements. The processor circuit may include a destination register that can be configured to store an output vector associated with the operation, and one or more source registers that can be configured to store corresponding operands of the one or more operands. The format circuit can be configured to perform a comparison of respective names of the one or more source registers and a name of the destination register. The execution circuit can be configured to perform, using the one or more operands and the predicate vector, the operation to generate the output vector. The execution circuit can be further configured to determine, based on a result of the comparison, respective values for inactive elements included in the output vector, where the inactive elements are determined by the predicate vector. The execution circuit can also be configured to write active elements of the output vector to the destination register, where the active elements are determined by the predicate vector.

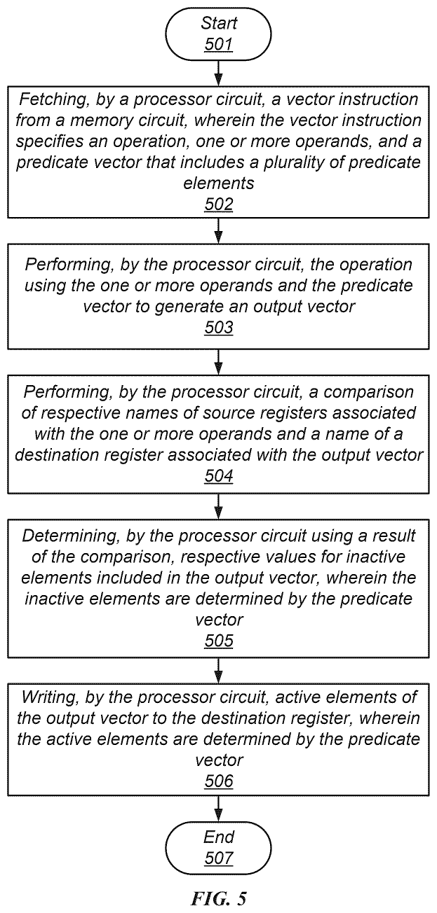

Turning to FIG. 5, a flow diagram depicting an embodiment of a method for operating a processor circuit is illustrated. The method, which may be applied to various processor circuits, e.g., processor circuit 100 as depicted in FIG. 1, begins in block 501.

The method includes fetching, by a processor circuit, a vector instruction from a memory circuit (block 502). In various embodiments, the vector instruction specifies an operation, one or more operands, and a predicate vector that includes a plurality of predicate elements.

The method further includes performing, by the processor circuit, the operation using the one or more operands and the predicate vector to generate an output vector (block 503). In various embodiments, the method may include identifying one or more elements of the one or more operands as inactive based on respective value of corresponding element positions in the predicate vector. In some embodiments, the method may also include decoding, by the processor circuit, the vector instruction prior to performing the operation.

The method also includes performing, by the processor circuit, a comparison of respective names of source registers associated with the one or more operands and a name of a destination register associated with the output vector (block 504). In some embodiments, the destination register includes a plurality of storage circuits. In various embodiments, performing the comparison of the respective source registers and the destination register includes comparing respective numbers that encode the names of the source registers to a number that encodes the name of destination register.

The method further includes determining, by the processor circuit using a result of the comparison, respective values for inactive elements included in the output vector (block 505). In various embodiments, the inactive elements are determined by the predicate vector.

The method also includes writing, by the processor circuit, active elements of the output vector to the destination register (block 506). In various embodiments, the active elements are determined by the predicate vector.

In some embodiments, determining the respective values for the inactive elements includes, in response to determining that the name of the destination register does not match the respective names of the one or more source registers, setting the inactive elements of the output vector to logical-0 values. In other embodiments, the method also includes writing, by the processor circuit, the logical-0 values, along with the active elements of the output vector, to the destination register.

In other embodiments, determining the respective values for the inactive elements of the output vector includes, in response to determining that the name of the destination registers matches a corresponding name of at least one of the respective source registers, retaining the values from the destination register that correspond to the inactive elements of the output vector. In some case, retaining the values from the destination register includes masking a write operation of the inactive elements of the output vector to the destination register.

In various embodiments, the destination register includes a plurality of storage circuits, and masking the write operation includes deactivating, based on the predicate vector, a plurality of write signals that control the write operation to corresponding ones of the plurality of storage circuits. In other embodiments, retaining the values from the destination register includes saving the values from the destination register and writing the values saved from the destination register, along with the active elements of the output vector, to the destination register. The method ends in block 507.

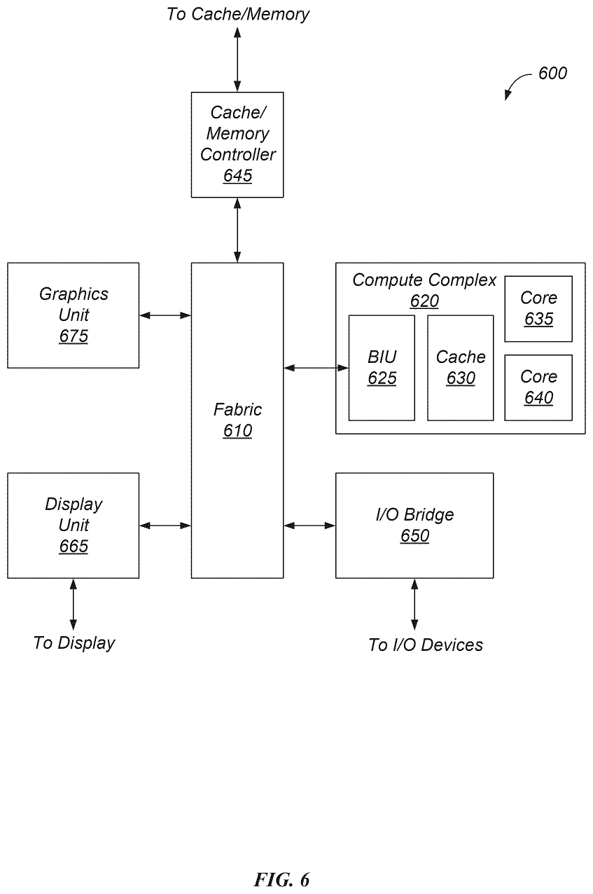

Referring now to FIG. 6, a block diagram illustrating an example embodiment of a device that includes a processor circuit that may correspond to processor circuit 100, is shown. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620, input/output (I/O) bridge 650, cache/memory controller 645, graphics unit 675, and display unit 665. In some embodiments, device 600 may include other components (not shown) in addition to, or in place of, the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol, and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores, and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600, may be configured to maintain coherency between various caches of device 600. BIU 625 may be configured to manage communication between compute complex 620 and other elements of device 600. Processor cores such as cores 625 and 640 may be configured to execute instructions of a particular instruction set architecture (ISA) which may include operating system instructions and user application instructions. These instructions may be stored in a computer readable medium such as a memory coupled to cache/memory controller 645 as discussed below.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Cache/memory controller 645 may be configured to manage transfer of data between fabric 610 and one or more caches and memories. For example, cache/memory controller 645 may be coupled to an L3 cache, which may, in turn, be coupled to a system memory. In other embodiments, cache/memory controller 645 may be directly coupled to a memory. In some embodiments, cache/memory controller 645 may include one or more internal caches. Memory coupled to cache/memory controller 645 may be any type of volatile memory, such as dynamic random access memory (DRAM), synchronous DRAM (SDRAM), double data rate (DDR, DDR2, DDR3, etc.), SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 645 may be any type of non-volatile memory such as NAND flash memory, NOR flash memory, nano RAM (NRAM), magneto-resistive RAM (MRAM), phase-change RAM (PRAM), Racetrack memory, Memristor memory, etc. As noted above, this memory may store program instructions executable by compute complex 620 to cause the computing device to perform functionality described herein.

Graphics unit 675 may include one or more processors, e.g., one or more graphics processing units (GPUs). Graphics unit 675 may receive graphics-oriented instructions, such as OPENGL®, Metal®, or DIRECT3D® instructions, for example. Graphics unit 675 may execute specialized GPU instructions or perform other operations based on the received graphics-oriented instructions. Graphics unit 675 may generally be configured to process large blocks of data in parallel, and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry, which may include highly parallel execution cores configured to execute graphics programs, which may include pixel tasks, vertex tasks, and compute tasks (which may or may not be graphics-related).

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), inter-integrated circuit (I2C), and radio-frequency interfaces, for example. Various types of peripherals and devices may be coupled to device 600 via I/O bridge 650.

In some embodiments, device 600 includes network interface circuitry (not explicitly shown), which may be connected to fabric 610 or I/O bridge 650. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 600 with connectivity to various types of other devices and networks.

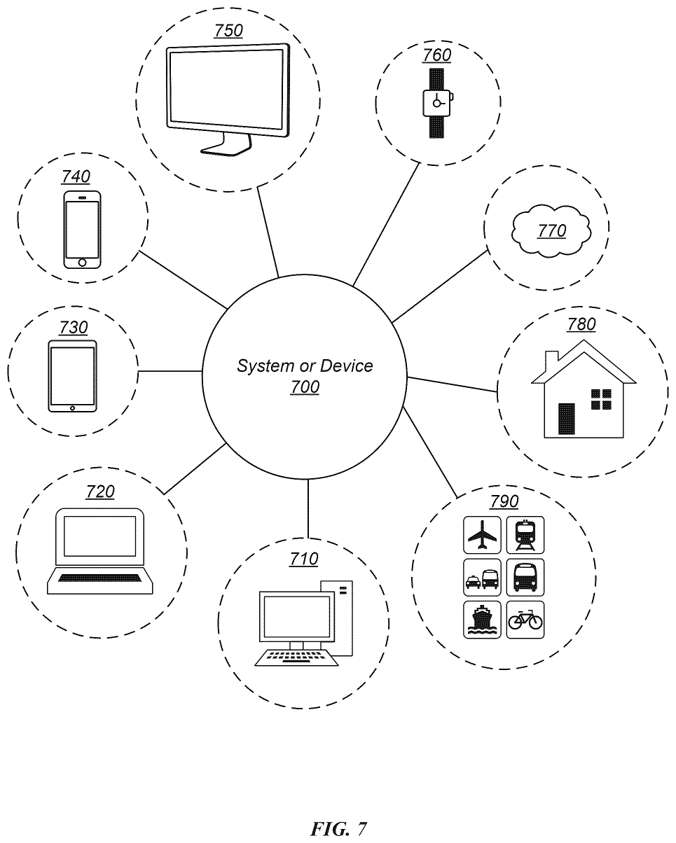

Turning now to FIG. 7, various types of systems that may include any of the circuits, devices, or system discussed above are illustrated. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

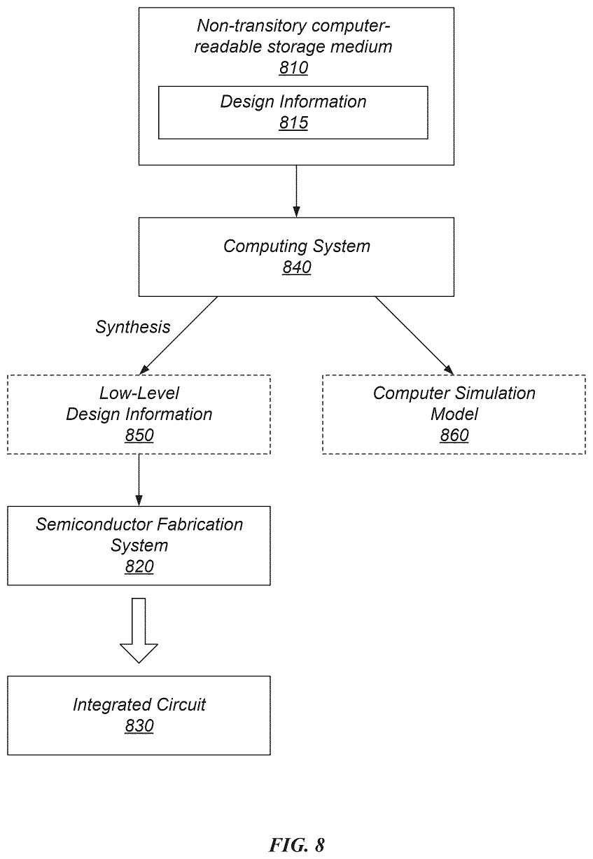

FIG. 8 is a block diagram illustrating an example of a non-transitory computer-readable storage medium that stores design information 815, according to some embodiments. In the illustrated embodiment, computing system 840 is configured to process design information 815. This may include executing instructions included in design information 815, interpreting instructions included in design information 815, compiling, transforming, or otherwise updating design information 815, etc. Therefore, design information 815 controls computing system 840 (e.g., by programming computing system 840) to perform various operations discussed below, in some embodiments.

In the illustrated example, computing system 840 processes design information 815 to generate both computer simulation model 860 of an integrated circuit 830 and low-level design information 850. In other embodiments, computing system 840 may generate only one of these outputs, may generate other outputs based on design information 815, or both. Regarding computer simulation model 860, computing system 840 may execute instructions of a hardware description language that includes register transfer level (RTL) code, behavioral code, structural code, or some combination thereof. The simulation model may perform the functionality specified by design information 815, facilitate verification of the functional correctness of the hardware design, generate power consumption estimates, generate timing estimates, etc.

In the illustrated example, computing system 840 also processes design information 815 to generate low-level design information 850 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 850 (potentially among other inputs), semiconductor fabrication system 820 is configured to fabricate integrated circuit 830 (which may correspond to functionality of the computer simulation model 860). Note that computing system 840 may generate different simulation models based on design information at various levels of description, including low-level design information 850, design information 815, and so on. The data representing low-level design information 850 and computer simulation model 860 may be stored on non-transitory computer-readable storage medium 810, or on one or more other media.

In some embodiments, low-level design information 850 controls (e.g., programs) semiconductor fabrication system 820 to fabricate integrated circuit 830. Thus, when processed by the fabrication system, the design information may program the fabrication system to fabricate a circuit that includes various circuitry disclosed herein.

Non-transitory computer-readable storage medium 810 may comprise any of various appropriate types of memory devices or storage devices. Non-transitory computer-readable storage medium 810 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 810 may include other types of non-transitory memory as well, or combinations thereof. Accordingly, non-transitory computer-readable storage medium 810 may include two or more memory media; such media may reside in different locations—for example, in different computer systems that are connected over a network.

Design information 815 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 840, semiconductor fabrication system 820, or both. In some embodiments, design information 815 may also include one or more cell libraries that specify the synthesis, layout, or both of integrated circuit 830. In some embodiments, design information 815 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 and computer simulation model 860 are configured to operate according to a circuit design specified by design information 815, which may include performing any of the functionality described herein. For example, integrated circuit 830 may include any of various elements shown in FIGS. 1 and 5. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 815. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 815 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 850. Low-level design information 850 may program semiconductor fabrication system 820 to fabricate integrated circuit 830.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a fetch circuit configured to retrieve a vector instruction from a memory circuit, wherein the vector instruction specifies an operation, one or more operands, and a predicate vector that includes a plurality of predicate elements;
a destination register configured to hold an output vector associated with the operation, and
one or more source registers configured to hold corresponding operands of the one or more operands;
a format circuit configured to perform a comparison of respective names of the one or more source registers and a name of destination register; and
an execution circuit configured to:
perform, using the one or more operands and the predicate vector, the operation to generate the output vector;
determine, based on a result of the comparison, respective values for inactive elements included in the output vector, wherein the inactive elements are determined by the predicate vector; and
write active elements of the output vector to the destination register, wherein the active elements of output vector are determined by the predicate vector.

2. The apparatus of claim 1, wherein to determine the respective values for the inactive elements of the output vector, the execution circuit is further configured, in response to a determination that the name of the destination register does not match the respective names of the one or more source registers, to set the inactive elements of the output vector to logical-0 values, and wherein the execution circuit is further configured to write the logical-0 values, along with the active elements of the output vector, to the destination register.

3. The apparatus of claim 1, wherein to determine the respective values for the inactive elements of the output vector, the execution circuit is further configured, in response to a determination that the name of the destination register matches a corresponding name of a particular source register of the one or more source registers, retain the values from the destination register that correspond to the inactive elements of the output vector.

4. The apparatus of claim 3, wherein to retain the values from the destination register, the execution circuit is further configured to mask a write operation of the inactive elements of the output vector to the destination register.

5. The apparatus of claim 4, wherein the destination register includes a plurality of storage circuits, and wherein to mask the write operation, the execution circuit is further configured to deactivate, based on the predicate vector, a plurality of write signals that control the write operation to corresponding ones of the plurality of storage circuits.

6. The apparatus of claim 3, wherein to retain the values from the destination register, the execution circuit is further configured to:
save the values from the destination register; and
write the values saved from the destination register, along with active elements of the output vector, to the destination register.

7. A method, comprising:
fetching, by a processor circuit, a vector instruction from a memory circuit, wherein the vector instruction specifies an operation, one or more operands, and a predicate vector that includes a plurality of predicate elements;
performing, by the processor circuit, the operation using the one or more operands and the predicate vector to generate an output vector;
performing, by the processor circuit, a comparison of respective names of source registers associated with the one or more operands and a name of a destination register associated with the output vector;
determining, by the processor circuit using a result of the comparison, respective values for inactive elements included in the output vector, wherein the inactive elements are determined by the predicate vector; and
writing, by the processor circuit using, active elements of the output vector to the destination register, wherein the active elements are determined by the predicate vector.

8. The method of claim 7, wherein determining the respective values for the inactive elements of the output vector includes, in response to determining that the name of the destination register does not match the respective names of the one or more source registers, setting the inactive elements of the output vector to logical-0 values, and further comprising writing, by the processor circuit, the logical-0 values, along with the active elements of the output vector, to the destination register.

9. The method of claim 7, wherein determining the respective values for the inactive elements of the output vector includes, in response to determining that the name of the destination register matches a corresponding name of a particular source register of the one or more source registers, retaining the values from the destination register that correspond to the inactive elements of the output vector.

10. The method of claim 9, wherein retaining the values from the destination register includes masking a write operation of the inactive elements of the output vector to the destination register.

11. The method of claim 10, wherein the destination register includes a plurality of storage circuits, and wherein masking the write operation includes deactivating, based on the predicate vector, a plurality of write signals that control the write operation to corresponding ones of the plurality of storage circuits.

12. The method of claim 9, wherein retaining the values from the destination register includes:
saving the values from the destination register; and
writing the values saved from the destination register, along with active elements of the output vector, to the destination register.

13. The method of claim 7, further comprising decoding, by the processor circuit, the vector instruction prior to performing the operation.

14. A system, comprising:
a memory circuit configured to store a plurality of instructions including at least one vector instruction that specifies an operation, one or more operands, and a predicate vector that includes a plurality of predicate elements;
a processor circuit configured to:
fetch the at least one vector instruction from the memory circuit;
perform, the one or more operands and the predicate vector, the operation to generate an output vector;
perform a comparison of respective names of source registers associated with the one or more operands and a name of a destination register associated with the output vector;
determine, using a result of the comparison, respective values for inactive elements included in the output vector, wherein the inactive elements are determined by the predicate vector; and
write active elements of the output vector to the destination register, wherein the active elements of the output vector are based on the predicate vector.

15. The system of claim 14, wherein to determine the respective values for the inactive elements of the output vector, the processor circuit is further configured, in response to a determination that the name of the destination register does not match the respective names of the one or more source registers, set the inactive elements of the output vector to logical-0 values, and wherein the processor circuit is further configured to write the logical-0 values, along with the active elements of the output vector, to the destination register.

16. The system of claim 14, wherein to determine the respective values for the inactive elements of the output vector, the processor circuit is further configured, in response to a determination that the name of the destination register matches a corresponding name of a particular source register of the one or more source registers, retain the values from the destination register that correspond to the inactive elements of the output vector.

17. The system of claim 16, wherein to retain the values from the destination register, the processor circuit is further configured to mask a write operation of the inactive elements of the output vector to the destination register.

18. The system of claim 17, wherein the destination register includes a plurality of storage circuits, and wherein to mask the write operation, the processor circuit is further configured to deactivate, based on the predicate vector, a plurality of write signals that control the write operation to corresponding ones of the plurality of storage circuits.

19. The system of claim 16, wherein to retain the values from the destination register, the processor circuit is further configured to:
save the values from the destination register; and
write the values saved from the destination register, along with active elements of the output vector, to the destination register.

20. The system of claim 14, wherein the processor circuit is further configured to decode the at least one vector instruction prior to performing the operation.
